(19) United States
(12) Patent Application Publication
(10) Pub. No.: US 2014/0192522 A1
(43) Pub. Date: Jul. 10, 2014

(54) Flashlight Tamper-Proof Structure

(71) Applicant: Shih-Hao Wang, Tainan City (TW)

(72) Inventor: Shih-Hao Wang, Tainan City (TW)

(21) Appl. No.: 13/733,935

(22) Filed: Jan. 4, 2013

(51) Int. Cl. F21V 17/04; F21L 4/00

(52) U.S. Cl. CPC F21V 17/04; F21L 4/00
USPC 362/202

(57) ABSTRACT

A flashlight tamper-proof structure for preventing a lamp cover fastened to an end of a flashlight from being unfastened manually is characterized in that: an appropriate section of an end of an opening of a body of the flashlight extends to form a carrying portion; an internal thread section penetrates a front end of the carrying portion; a hole is formed at a corresponding point of a rear end of the carrying portion, to allow a screw to be inserted into the carrying portion, such that the screw is screwed to the internal thread section with a tool; concave indentations are formed at the periphery of the opening of the lamp cover fastened to the end of the opening of the body of the flashlight; and the screw screwed to the internal thread section is moved forward with the tool to reach the concave indentations.

### BACKGROUND OF THE INVENTION

1. Technical Field

The present invention provides a flashlight tamper-proof structure characterized in that: an appropriate section of an end of an opening of a body of a flashlight capable of illumination extends to form a carrying portion; a screw is inserted and screwed to an internal thread section of the front end; and a plurality of concave indentations is formed at the periphery of the opening of the lamp cover fastened to the end of the opening of the body of the flashlight. The screw screwed to the internal thread section of the front end of the carrying portion on one side of the body of the flashlight can be moved forward with the tool to reach the concave indentations at the periphery of the lamp cover. Accordingly, the lamp cover fastened to an end of the flashlight cannot be unfastened manually.

2. Description of Related Art

A conventional flashlight capable of illumination has to meet a safety standard (UL): a lamp cover of the flashlight cannot be manually unfastened but can only be unfastened with a tool. To this end, related manufacturers put forth a flashlight characterized in that the flashlight essentially comprises a flashlight body and a lamp cover which are tightly engaged with each other when put together or are integrally formed as a unitary structure, such that a user needs a tool to separate the flashlight body and the lamp cover in order to change a light bulb therein or has to dismount from or mount on the other end of the flashlight body an object.

Therefore, it imperative to provide a flashlight tamper-proof structure for preventing a lamp cover from being unfastened without a tool.

### SUMMARY OF THE INVENTION

The present invention provides a flashlight tamper-proof structure for preventing a lamp cover fastened to a front end of an illumination-oriented flashlight from being unfastened manually. The flashlight tamper-proof structure is characterized in that: an appropriate section of an end of an opening of a body of a flashlight extends to form a carrying portion to allow a screw to be inserted into the opening and screwed to an internal thread section penetrating the front end; a plurality of concave indentations is formed at the periphery of the opening of the lamp cover fastened to the end of the opening of the body of the flashlight, such that the screw screwed to the front end of the carrying portion on one side of the body of the flashlight can be moved forward to reach the concave indentations at the periphery of the lamp cover. Accordingly, the lamp cover fastened to an end of the flashlight cannot be unfastened manually.

The first objective of the present invention is to prevent a lamp cover fastened to an end of a flashlight from being unfastened manually. The present invention is characterized in that: an appropriate section of an end of an opening of a body of a flashlight extends to form a carrying portion; an internal thread section penetrates a front end of the carrying portion; a hole is formed at a corresponding point of a rear end of the carrying portion, to allow a screw to be inserted into the carrying portion, such that the screw is screwed to the internal thread section of the front end with a tool; a plurality of concave indentations is formed at the periphery of the opening of the lamp cover fastened to the end of the opening of the body of the flashlight; and the screw screwed to the front end of the carrying portion on one side of the body of the flashlight can be moved forward with the tool to reach the concave indentations at the periphery of the lamp cover. Accordingly, the lamp cover fastened to an end of the flashlight cannot be unfastened manually.

The second objective of the present invention is that the internal thread section penetrating the front end of the carrying portion formed by extending an appropriate section of an end of an opening of a body of a flashlight can be implemented by a nut embedded at the front end of the carrying portion.

The third objective of the present invention is that the carrying portion formed by extending an appropriate section of an end of an opening of a body of a flashlight forms a channel-shaped container opening at the top thereof to allow the screw screwed to the internal thread section at the front end of the carrying portion to fall into between the carrying portion after the screw has been unfastened, such that the screw can be conveniently screwed again at any time and moved forward to reach the concave indentations at an end of the lamp cover.

The fourth objective of the present invention is that the diameter of a hole at a rear end of the carrying portion formed by extending an appropriate section of an end of an opening of a body of a flashlight permits admission of an end of a conventional tool for use in fastening the screw.

### BRIEF DESCRIPTION OF THE SEVERAL VIEWS OF THE DRAWINGS

FIG. 1 is an exploded view of a flashlight tamper-proof structure according to the present invention;

FIG. 2 is a schematic view of assembly and operation of the flashlight tamper-proof structure according to the present invention;

FIG. 3 is an enlarged view of a portion of the flashlight tamper-proof structure according to the present invention; and

FIG. 4 is a cross-sectional view of the flashlight tamper-proof structure taken along line 40-40 of FIG. 3.

### DETAILED DESCRIPTION OF THE EMBODIMENT OF THE INVENTION

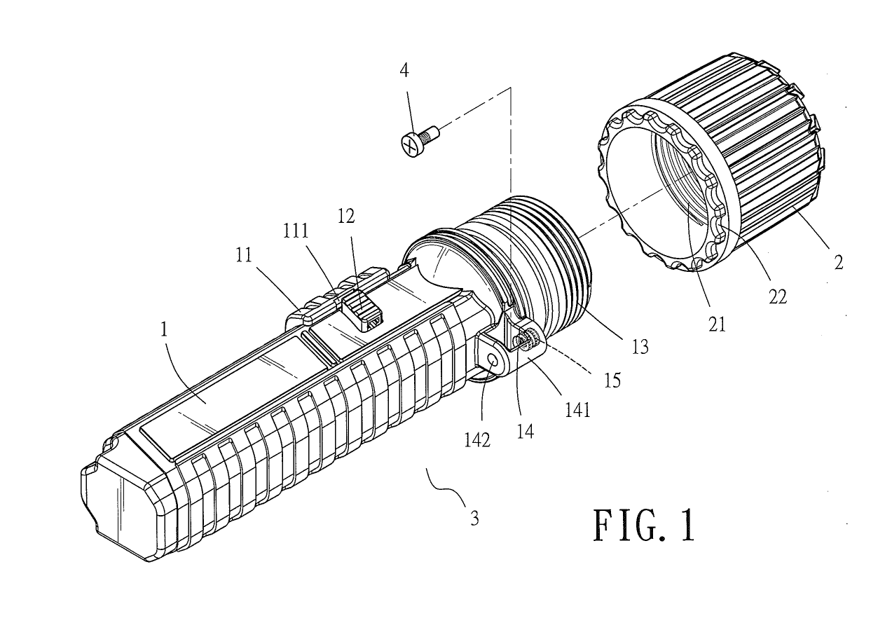

Referring to FIG. 1, the present invention provides a flashlight tamper-proof structure for preventing a lamp cover 2 fastened to an end of an opening of a body 1 of a flashlight 3 from being unfastened manually. The flashlight tamper-proof structure essentially comprises the body 1 and the lamp cover 2.

The body 1 has therein a space for receiving a power-supplying battery. A power switch 11 is disposed at the periphery of one side of the body 1 and adapted to control the ON/OFF of a flashlight lamp. A security switch 12 is pivotally disposed at a predetermined segment of the power switch 11 at the body 1 and adapted to be movably pushed in or moved out for controllably pushing the power switch 11 into a laterally-positioned recess portion 111 whenever the power switch 11 is not in use to thereby prevent the power switch 11 from being wrongly turned on. An end of the opening of the body 1 extends to form an external thread section 13 for fastening the lamp cover 2. An appropriate section of the end of the opening of the body 1 extends to form a carrying portion 14 (wherein, in this embodiment, the carrying portion 14 is provided in the form of a channel-shaped container that opens at the top thereof). An internal thread section 141 penetrates the front end of the carrying portion 14 (wherein the internal thread section 141 penetrating the front end of the carrying portion is implemented by a nut 15 embedded at the front end of the carrying portion 14). A hole 142 is formed at a corresponding point of a rear end of the carrying portion 14, to allow a screw 4 to be inserted into the carrying portion 14, such that the screw 4 is screwed to the internal thread section 141 of the front end with a tool 5 (wherein the diameter of the hole 142 at the rear end of the carrying portion 14 permits admission of an end of the tool 5 for use in fastening the screw 4.)

The coverage of the flashlight lamp by the lamp cover 2 depends on the external thread section 13 extending from an end of the opening of the body 1. An internal thread section 21 is formed inside the lamp cover 2. A plurality of concave indentations 22 is formed at the periphery of the opening of the lamp cover 2 (wherein the internal thread section 21 and the concave indentations 22 at the opening of the lamp cover 2 can be implemented together in the form of an element, such that the element and the lamp cover 2 are integrally formed as a unitary structure by bagging.)

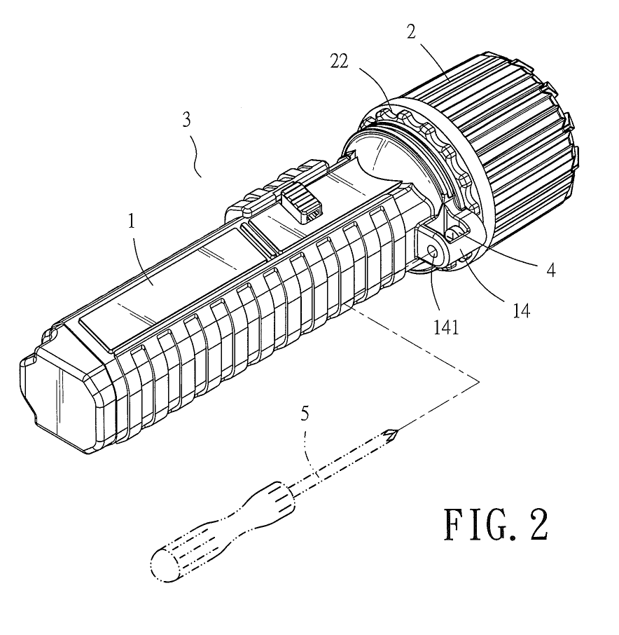

Referring to FIG. 1 and FIG. 2, there are shown diagrams of the fastening together of the body 1 and the lamp cover 2.

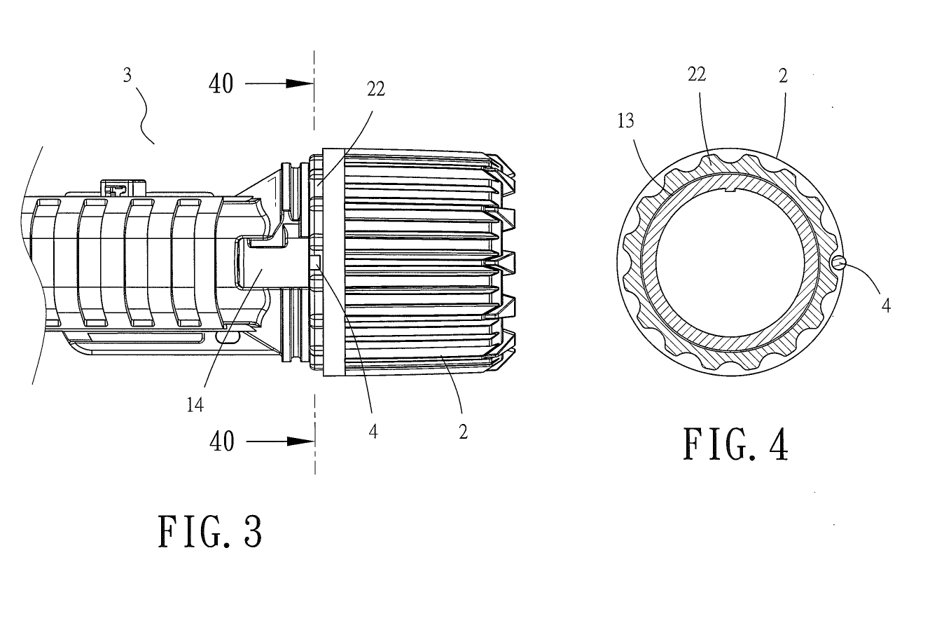

Step 1: fastening the lamp cover 2 to the external thread section 13 at an end of the opening of the body 1. Step 2: positioning the screw 4 in between the carrying portion 14 on one side of the body 1, and guiding, with the tool 5 (in the form of a screwdriver), the screw 4 into the hole 142 at the rear end of the carrying portion 14 such that the screw 4 is screwed to the internal thread section 141 at the front end to thereby allow the screw 4 to move forward to reach the concave indentations 22 at the periphery of the lamp cover 2 (see FIG. 3 and FIG. 4). Accordingly, the lamp cover 2 fastened to an end of the body 1 of the flashlight cannot be unfastened manually.

Unfastening the lamp cover 2 which is otherwise fastened to an end of the opening of the body 1 entails: unscrewing the screw 4 from the front end of the carrying portion 14 on one side of the body 1 by means of the tool 5 such that the screw 4 is released from the concave indentations 22 at the periphery of the opening of the lamp cover 2, and the screw 4 thus loosened can fall into between the carrying portion 14, thereby allowing the screw 4 to be conveniently screwed again at any time and moved forward to reach the concave indentations 22 at the end of the lamp cover 2. Accordingly, the flashlight tamper-proof structure meets a safety standard (UL) of flashlight products: a lamp cover of a flashlight cannot be unfastened without a tool.

What is claimed is:

1. A flashlight tamper-proof structure for preventing a lamp cover fastened to an end of a flashlight from being unfastened manually, characterized in that: an appropriate section of an end of an opening of a body of the flashlight extends to form a carrying portion; an internal thread section penetrates a front end of the carrying portion; a hole is formed at a corresponding point of a rear end of the carrying portion, to allow a screw to be inserted into the carrying portion, such that the screw is screwed to the internal thread section of the front end with a tool; a plurality of concave indentations is formed at a periphery of an opening of the lamp cover fastened to the end of the opening of the body of the flashlight, such that the screw screwed to the front end of the carrying portion on one side of the body of the flashlight can be moved forward with the tool to reach the concave indentations at the periphery of the lamp cover, and thus the lamp cover fastened to an end of the flashlight cannot be unfastened manually.

2. The flashlight tamper-proof structure of claim 1, wherein the internal thread section penetrating the front end of the carrying portion formed by extending the appropriate section of the end of the opening of the body of the flashlight can be implemented by a nut embedded at the front end of the carrying portion.

3. The flashlight tamper-proof structure of claim 1, wherein the carrying portion formed by extending the appropriate section of the end of the opening of the body of the flashlight forms a channel-shaped container opening at the top thereof to allow the screw screwed to the internal thread section at the front end of the carrying portion to fall into between the carrying portion after the screw has been unfastened, such that the screw can be conveniently screwed again at any time and moved forward to reach the concave indentations at the end of the lamp cover.

4. The flashlight tamper-proof structure of claim 1, wherein the diameter of the hole at the rear end of the carrying portion formed by extending the appropriate section of the end of the opening of the body of the flashlight permits admission of an end of the tool for use in fastening the screw.
